(19) United States
(12) Patent Application Publication
(10) Pub. No.: US 2016/0336103 A1
(43) Pub. Date: Nov. 17, 2016

(54) ELECTRIC SOLENOID AND USE OF AN ELECTRIC SOLENOID

(71) Applicant: Robert Bosch GmbH, Stuttgart (DE)

(72) Inventors: Robert Giezendanner-Thoben, Gerlingen (DE); Bernd Stuke, Leonberg (DE); Martin Koehne, Asperg (DE)

(21) Appl. No.: 15/106,278

(22) PCT Filed: Dec. 3, 2014
(86) PCT No.: PCT/EP2014/076381

§ 371 Date: Jun. 17, 2016

(30) Foreign Application Priority Data
Dec. 19, 2013 (DE) 10 2013 226 572.7

(51) Int. Cl. H01F 7/06; F02M 51/06

(52) U.S. Cl. CPC H01F 7/06; F02M 51/061

(57) ABSTRACT

The invention relates to an electric solenoid (10) comprising at least one solenoid body (11) and a magnet wire (25; 25a) surrounding the solenoid body (11) in the form of at least one winding on a peripheral surface (16) of said solenoid body (11), the magnet wire (25; 25a) consisting of an electrically conductive wire core (23) and an insulation layer (26) which at least partially surrounds the wire core (23). According to the invention, the wire core (23) consists of aluminium (21) and graphene (22) which is in electrically conductive contact with the aluminium (21).

### BACKGROUND OF THE INVENTION

The invention relates to an electric solenoid. The invention also relates to the use of an electric solenoid.

An electric solenoid is already known from practice as part of a fuel injector for injecting fuel into the combustion chamber of an internal combustion engine. In particular, the electric solenoid is used to actuate, directly or indirectly, an injection member, for example in the form of a nozzle needle, in order to close or expose injection openings formed in the fuel injector.

Conventional electric solenoids have a solenoid body consisting of plastic, onto which a large number of windings of a coil wire are wound. The coil wire usually consists of a wire core made of copper, which is surrounded by an insulator layer, for example bonding varnish. The use of copper as a wire core does indeed have the advantage of a relatively low specific resistance, however this resistance is temperature-dependent, such that with rising temperature the resistance of the copper wire also increases. This means that, during operation for example of a fuel injector, which is inserted in a cylinder head of an internal combustion engine, the temperature of the fuel injector and therefore also the temperature of the electric solenoid increases, which leads to an increased electrical resistance of the coil wire. This results in a decreasing magnetic force with increasing temperature, such that the fault-free functioning for example of an injection member may be critical at high temperatures. For this reason it is usual to increase the packing or power density of electric solenoids of this type. This is implemented for example by a profile wire, with which it is made possible to increase the degree of filling of the wire windings on a solenoid body.

Since fuel injection systems are tending more and more toward high system pressures and therefore also toward higher necessary actuation forces for an injection member, future demands will be satisfied with increasing difficulty with conventional electric solenoids according to the prior art without increasing the overall size of an electric solenoid.

### SUMMARY OF THE INVENTION

Proceeding from the presented prior art, the object of the invention is to develop an electric solenoid such that the heavily temperature-dependent resistance characteristic of the prior art electric solenoid is reduced. In addition, a maximum power density, i.e. a maximum magnetic actuation force with a certain overall size of a solenoid body, should be obtainable. This object is achieved in accordance with the invention with an electric solenoid having the features of claim 1 in that the wire core of the coil wire consists of aluminum and graphene arranged in electrically conductive contact with the aluminum. A material matrix of this type has the advantage that it has a combination of a relatively low resistance change over the temperature profile, this being known from aluminum, and has a relatively low specific resistance as considered on the whole, similarly to the use of copper.

In order to provide the discussed material combination according to the invention, the graphene in a first embodiment of the invention is distributed in the aluminum at least substantially homogeneously in the cross section of the wire core and is oriented in the current conduction direction. It should be noted in this respect that graphene is usually configured in the form of small plates, i.e. elements having a very thin cross section, such that it is essential that the graphene is oriented in the current conduction direction. Here, it may be possible that the individual graphene elements are physically separated from one another as considered in the current conduction direction, or, particularly advantageously, are arranged overlapping one another, such that a continuously conductive graphene layer is attained in the current conduction direction. Should the individual graphene elements be separated from one another in the current conduction direction, an electrical conduction takes place between the graphene elements through the aluminum arranged in electrically conductive contact with the graphene. It is therefore also important or essential that within the cross section there are at least substantially no effects reducing the current conduction, such as air inclusions or the like.

In an alternative embodiment of the invention it is also possible for the graphene to be formed as a layer that is separate from the aluminum, is electrically conductively connected to the aluminum, and is preferably continuous in the current direction, said layer preferably being formed on a surface of the wire core. In an embodiment of this type it is considered to be advantageous that the two component parts serving for current conduction, i.e. the aluminum and the graphene, can be formed where appropriate in separate production processes or production steps, said component parts then being electrically conductively connected to one another. Alternatively, it is also possible to arrange or to deposit the graphene on an aluminum layer or an aluminum support already provided. The aluminum thus serves as support material for the arrangement or provision of the graphene.

In the prior art the plastics insulation layers usually used (for example bonding varnish) have a thickness of approximately 50 μm in the case of the use of copper wires. Since the insulation layer does not serve for current conduction, there is a decreasing packing density or performance of the electric solenoid with an increasing thickness of the insulation layer. For this reason, in accordance with the invention, the insulation layer is particularly preferably an aluminum oxide layer having a thickness between 1 μm and 10 μm, preferably between 2 μm and 5 μm. An oxide layer, by contrast with the use of plastic, in particular has the advantage that it has a high thermal conductivity and therefore also enables a relatively effective removal of the heat of the coil wire. In addition, due to the particularly thin design of the insulation layer compared with an insulation layer consisting of plastic, the performance of the electric solenoid is augmented by an increased fullness factor. The coating or design with aluminum oxide is implemented in particular by anodic oxidation (Eloxal process). The anodic oxidation is an electrolytic method, by which an oxide layer is produced on a surface, which oxide layer is approximately one hundred times greater than a naturally formed (oxide) layer, such that, with sufficient dielectric breakdown strength, an insulation layer 4 μm thick is sufficient in practice.

In accordance with a particular embodiment of the insulation layer, the insulation layer covers the graphene merely in part. This is provided in particular when aluminum strips are used, with which the graphene is applied on one side as coating. Since the graphene serves for current conduction and has a very low electrical resistance, it is essential here that when winding the coil wire over itself, an insulation layer covers the partially exposed graphene layers arranged beneath each layer of the coil wire.

In addition, a geometric embodiment of the coil wire in which this has at least substantially a rectangular cross section is most preferred. A design of this type increases the fullness factor and therefore the power density of the electric solenoid to a particularly high degree and therefore enables particularly small or compact electric solenoids with a certain power.

In accordance with a preferred embodiment, so as to be able to wind a coil wire of this type having a rectangular cross section over the entire axial length of a solenoid body in order to enable a maximum power density or a maximum fullness factor, the coil wire additionally has a width corresponding to the width of the solenoid body in the longitudinal direction thereof.

However, the same effect can also be obtained alternatively when the coil wire has a width corresponding to 1/n times the width of the solenoid body in the longitudinal direction thereof, and when two coil wires adjacent to one another in the longitudinal direction of the solenoid body are electrically conductively connected to one another.

The discussed advantageous effects of the electric solenoids according to the invention are particularly effective when the electric solenoids are exposed at least temporarily to different temperatures, wherein at temperatures of more than 150° C., in particular more than 200° C., the advantages compared with conventional electric solenoids are particularly significant.

An electric solenoid of this type according to the invention is therefore used in particular as part of a motor vehicle injection component, in particular a fuel injector, in which the fuel injector or electric solenoid thereof on the one hand is exposed to relatively low temperatures, for example in the case of a cold start, and on the other hand can reach the discussed high temperatures of up to more than 200° C. during operation. In principle, the electric solenoid according to the invention can be used in all applications in which a particularly high performance and/or a small installation space is/are desired for the electric solenoid.

### BRIEF DESCRIPTION OF THE DRAWINGS

Further advantages, features and details of the invention will become clear from the following description of preferred exemplary embodiments and on the basis of the drawings, in which:

FIG. 1 shows a longitudinal section through an electric solenoid, in which two coil wire units are arranged adjacently as considered in the longitudinal direction,

FIG. 2 shows a perspective illustration of a coil wire element formed as a roll,

FIG. 3 shows a cross section through a first coil wire element according to the invention,

FIG. 4 shows a cross section through a coil wire element modified compared with FIG. 3, and

FIG. 5 shows an illustration of the resistance profile of different materials over temperature.

### DETAILED DESCRIPTION

Like elements or elements having the same function are provided in the figures with like reference numerals.

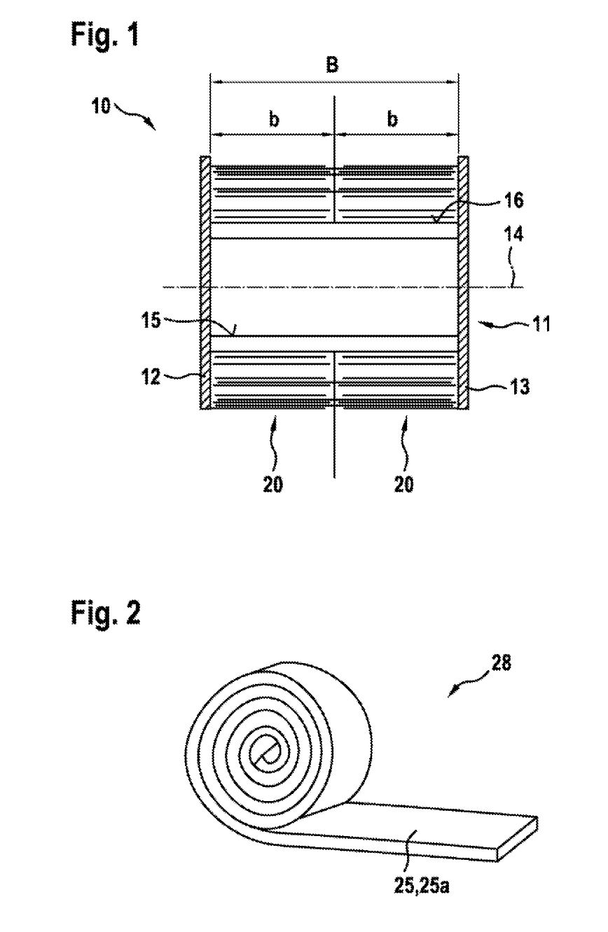

FIG. 1 illustrates an electric solenoid 10 according to the invention, as is used for example as part of a motor vehicle injection component in the form of a fuel injector. In particular, the electric solenoid 10 is used here for the at least indirect actuation of an injection valve member (nozzle needle) in the fuel injector.

The electric solenoid 10 comprises a solenoid body 11, consisting of plastic and produced by means of injection molding, in the form of a sleeve having two laterally arranged flanges 12, 13, which delimit the solenoid body 11 in the longitudinal direction and run around radially, and a recess 15 arranged in the solenoid body 11 concentrically with the longitudinal axis 14 thereof. Between the two flanges 12, 13, the solenoid body 11 forms a peripheral surface 16, which in particular is circular, for arrangement of at least one coil wire unit 20. In the illustrated exemplary embodiment, as considered in the axial direction of the longitudinal axis 14, there are provided two coil wire units 20 on the solenoid body 11, which are electrically conductively connected to one another (not illustrated) in that a wire end of one coil wire unit 20 is connected to a wire end of the other coil wire unit 20. In particular, the width b of the two identical coil wire units 20 is approximately half the width B of the solenoid body 11 between the two flanges 12, 13, such that the space between the two flanges 12, 13 is filled at least practically completely.

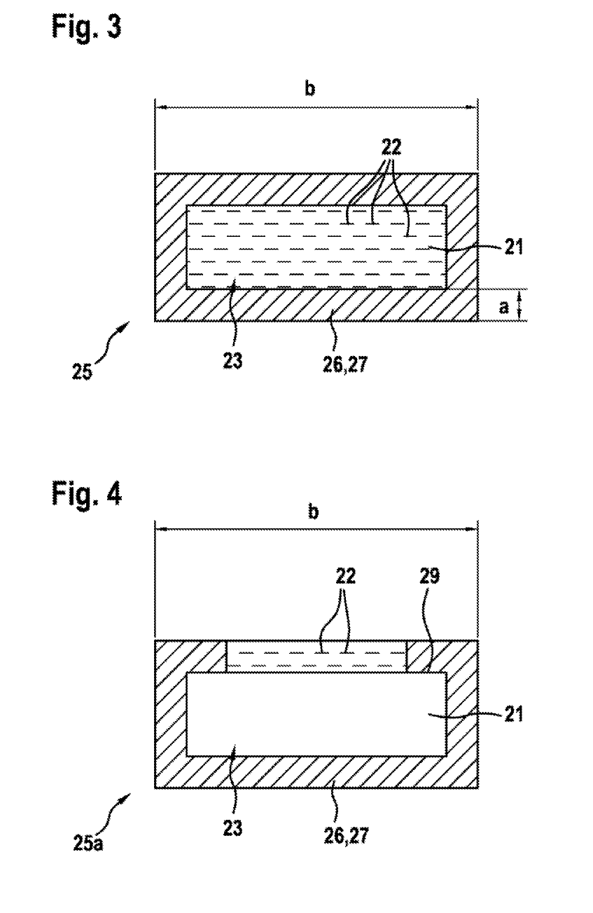

As can be seen on the basis of an overview of FIGS. 2 to 4, the coil wire 25, 25a of the coil wire unit 20, which is wound in the form of a multiplicity of windings on the solenoid body 11, consists of two different materials, more specifically of aluminum 21 and of graphene 22. In the embodiment according to FIG. 3 the coil wire 25 has a wire core 23 consisting of aluminum 21. In the current conduction direction, i.e. perpendicularly to the drawing plane of FIG. 3, small plates made of graphene 22 are arranged in the aluminum 21, wherein the small plates arranged perpendicularly to the drawing plane of FIG. 3 either are all electrically conductively connected to one another directly in the form of a strip, or are arranged at distances from one another. In particular, the distribution of the graphene 22 within the wire core 23 or the aluminum 21 is at least substantially homogenous.

The coil wire 25, which has a rectangular cross section of width b, is surrounded by an insulation 26, which in particular has a constant wall thickness a over the entire cross section of the coil wire 25. The insulation layer 26 is formed as an aluminum oxide layer 27 and is produced by way of example by means of the Eloxal process. In particular, the wall thickness a of the insulation layer 26 is between 1 μm and 10 μm, preferably between 2 μm and 5 μm, most preferably 4 μm. A coil wire 25 produced in this way can be stored or mechanically processed in the form of a wound strip 28 in accordance with the illustration of FIG. 2.

A coil wire 25a that has been modified compared with FIG. 3 is illustrated in FIG. 4. The wire core 23 of the coil wire 25a consists of aluminum 21 without graphene 22. The graphene 22 is applied as a strip-like layer to the surface or to the upper side 29 of the wire core 23 and is electrically conductively connected thereto. The insulation layer 26 likewise consists of an aluminum oxide layer 27, which completely surrounds the wire core 23 in the region outside the graphene 22. In the region of the graphene 22 the insulation layer 26 extends laterally as far as the graphene 22, however the graphene 22 is not surrounded or covered by the insulation layer 26 on the upper side facing away from the wire core 23.

When winding the coil wire 25a onto the solenoid body 11, it is essential that a number of layers of the coil wire 25a are arranged or wound one above the other such that an insulation layer 26 of a winding arranged above is in each case wound onto the graphene 22 of a radially lower layer.

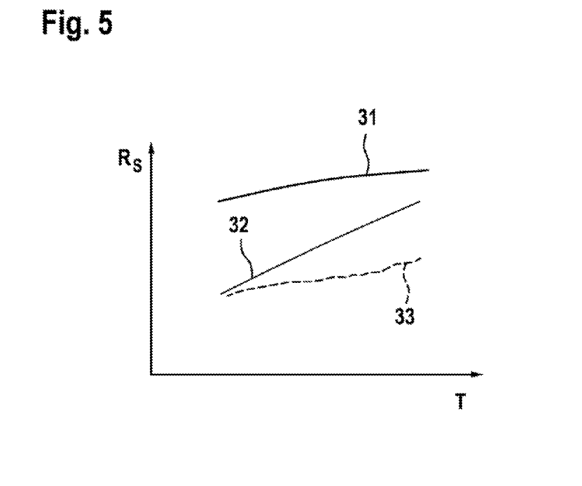

FIG. 5 illustrates the specific resistance RS (Y-axis) of different materials over temperature T (x-axis). Reference 31 designates the profile of the specific resistance RS of aluminum, whereas reference 32 shows the profile of the specific resistance RS of copper. Reference 33 is the specific resistance RS of the material combination according to the invention consisting of aluminum 21 and graphene 22. It can be seen that a material combination of this type with rising temperature has a practically constant or only slightly rising specific resistance RS, which, in terms of its absolute value, lies in the region of copper at relatively low temperatures.

The electric solenoid 10 according to the invention can be altered or modified in many different ways without departing from the inventive concept. By way of example, it is conceivable, instead of a substantially rectangular cross section for the coil wire 25, 25a, to form this cross section as a square or, in the case of the graphene 22 arranged in the aluminum 21, in a round shape. It should also be noted again that the use of the invention is not limited to electric solenoids 10 used as part of a fuel injection component.

1. An electric solenoid (10), comprising at least one solenoid body (11) and a coil wire (25; 25a) surrounding the solenoid body (11) on a peripheral surface (16) of the solenoid body (11) in the form of at least one winding, wherein the coil wire (25; 25a) consists of an electrically conductive wire core (23) and an insulating layer (26) surrounding the wire core (23) at least in regions,
characterized in that the wire core (23) comprises aluminum (21) and graphene (22) arranged in electrically conductive contact with the aluminum (21).

2. The electric solenoid as claimed in claim 1, characterized in that the graphene (22) is distributed in the aluminum (21) at least substantially homogenously in a cross section of the wire core (23) and is oriented in current conduction direction.

3. The electric solenoid as claimed in claim 1, characterized in that the graphene (22) is formed as a layer, which is separate from the aluminum (21), and is electrically conductively connected to the aluminum (21).

4. The electric solenoid as claimed in claim 1, characterized in that the insulation layer (26) is an aluminum oxide layer (27) having a thickness (a) between 1 μm and 10 μm.

5. The electric solenoid as claimed in claim 3, characterized in that the insulation layer (26) covers the graphene (22) only in part.

6. The electric solenoid as claimed in claim 1, characterized in that the coil wire (25; 25a) has an at least substantially rectangular cross section.

7. The electric solenoid as claimed in claim 6, characterized in that the coil wire (25; 25a) has a width (b) corresponding at least substantially to an axial width (B) of the solenoid body (11) in a longitudinal direction thereof.

8. The electric solenoid as claimed in claim 6, characterized in that the coil wire (25; 25a) has a width (b) corresponding at least substantially to 1/n times a width (B) of the solenoid body (11) in a longitudinal direction thereof, and in that two coil wires (25; 25a) adjacent to one another in the longitudinal direction of the solenoid body (11) are electrically conductively connected to one another.

9. (canceled)

10. (canceled)

11. A motor vehicle injection component comprising an electric solenoid (10) as claimed in claim 1.

12. The motor vehicle injection component as claimed in claim 11, wherein the component is a fuel injector.

13. The electric solenoid as claimed in claim 1, characterized in that the graphene (22) is formed as a layer, which is separate from the aluminum (21), is electrically conductively connected to the aluminum (21), and is continuous in a current direction.

14. The electric solenoid as claimed in claim 1, characterized in that the graphene (22) is formed as a layer, which is separate from the aluminum (21), is electrically conductively connected to the aluminum (21), and is continuous in a current direction on an upper side (29) of the wire core (23).

15. The electric solenoid as claimed in claim 1, characterized in that the insulation layer (26) is an aluminum oxide layer (27) having a thickness (a) between 2 μm and 5 μm.
